(19) United States
(12) Patent Application Publication
(10) Pub. No.: US 2007/0176491 A1
(43) Pub. Date: Aug. 2, 2007

(54) Digital doorlock having ultra capacitor

(76) Inventors: Jin-A Kang, Gyeonggi-do (KR); Jae-Hyun Kim, Gyeonggi-do (KR)

Correspondence Address: JONES DAY, 222 EAST 41ST ST, NEW YORK, NY, 10017, US

(21) Appl. No.: 11/650,061

(22) Filed: Jan. 4, 2007

(30) Foreign Application Priority Data
Jan. 6, 2006 (KR) 10-2006-0001275

(51) Int. Cl. B60L 1/00

(52) U.S. Cl. 307/10.1

(57) ABSTRACT

A digital doorlock having an ultra capacitor is used as an emergency power. The digital doorlock includes a power source for supplying an ordinary power; a key recognition means for receiving a key required for opening a doorlock from outside; a doorlock opening/closing means for opening/closing the doorlock by comparing an input key with a key stored therein; an emergency power generating means for generating an emergency power and converting the generated power suitably for charging capacitors; and a capacitor unit provided with capacitors to store the electric energy applied from the emergency power generating means into the capacitors and supplying the energy stored in the capacitors to the doorlock opening/closing means in case the power supply is not able to supply power. This doorlock apparatus has a simplified configuration since a separate emergency opening/closing device for preparation against a complete consumption of the battery is not used.

### BACKGROUND OF THE INVENTION

1. Field of the Invention

The present invention relates to a digital doorlock, and more particularly to a digital doorlock having an ultra capacitor, which may be used as an emergency power.

2. Description of the Related Art

Generally, a doorlock is installed to a door of a place such as a house, an apartment and an office so as to prevent an outsider with no authority from invading into a building.

A locking device is installed to the doorlock so that a door may not be arbitrarily opened from outside. A mechanical doorlock that is locked or unlocked using a key is the most general one. However, the mechanical doorlock has a simple configuration, which is fragile in safety.

In order to solve this problem, a digital doorlock that is locked or unlocked by operating a solenoid electromagnet and a clutch by means of secret number, fingerprint recognition or card recognition is widely used.

The digital doorlock has a battery in a door so as to operate its electronic component. However, if the battery is consumed completely, it is difficult to open the door from outside.

### SUMMARY OF THE INVENTION

The present invention is designed to solve the problems of the prior art, and therefore it is an object of the present invention to provide a doorlock capable of generating and supplying an emergency power when a battery used in the doorlock is completely discharged.

In order to accomplish the above object, the present invention provides a digital doorlock, which includes a power source for supplying an ordinary power; a key recognition means for receiving a key required for opening a doorlock from outside; a doorlock opening/closing means for opening/closing the doorlock by comparing a key input from the key recognition means with a key stored therein; an emergency power generating means for generating an emergency power and controlling the generated power to be converted into a power required for charging capacitors; and a capacitor unit provided with a plurality of capacitors and storing the electric energy applied from the emergency power generating means into the capacitors, the capacitor unit supplying the energy stored in the capacitors to the doorlock opening/closing means in case the power supply is not able to supply power.

Preferably, the capacitor unit includes a balancing circuit for controlling a balance of the capacitors with respect to a charged voltage; and an output circuit for outputting the energy respectively stored in the capacitors together.

Also preferably, the capacitor unit further includes a switching means capable of selectively connecting the balancing circuit and the output circuit.

### BRIEF DESCRIPTION OF THE DRAWINGS

Other objects and aspects of the present invention will become apparent from the following description of embodiments with reference to the accompanying drawing in which:

FIG. 1 is a block diagram showing a digital doorlock according to a preferred embodiment of the present invention;

FIG. 2 is a detailed block diagram showing an emergency power generating means according to a preferred embodiment of the present invention; and

FIG. 3 is a detailed block diagram showing a capacitor unit according to a preferred embodiment of the present invention.

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

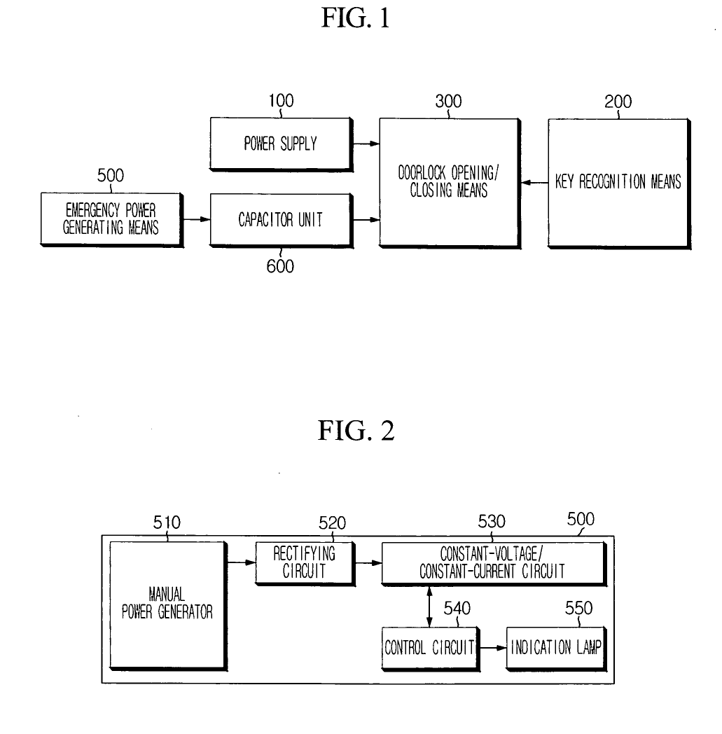

FIG. 1 is a block diagram showing a digital doorlock according to a preferred embodiment of the present invention. Referring to FIG. 1, the digital doorlock of this embodiment includes a power supply 100, a key recognition means 200, a doorlock opening/closing means 300, an emergency power generating means 500, and a capacitor unit 600.

The power supply 100 is used for supplying power to the doorlock opening/closing means 300 at ordinary times, and a common battery pack is employed.

The key recognition means 200 is used for recognizing an input digital key in order to certify opening/closing of the digital doorlock, and a means capable of receiving a digital key such as a keypad, a fingerprint recognition means or a RFID carder reader may be used.

In addition, the key recognition means 200 is configured so that the digital key may be changed, and it receives the digital key to be temporarily stored in the doorlock opening/closing means 300.

The doorlock opening/closing means 300 has a memory (not shown) for storing a digital key. The doorlock opening/closing means 300 compares a digital key (k1) stored in the memory with a digital key (k2) input from the key recognition means 200. In addition, the doorlock opening/closing means 300 checks coincidence of both digital keys (k1 and k2) and then opens or closes the doorlock.

The emergency power generating means 500 generates energy to be stored in the capacitor unit 600. In addition, the emergency power generating means 500 applies the generated power to the capacitor unit 600.

The capacitor unit 600 converts the energy applied from the emergency power generating means 500 into a power required for operating the doorlock opening/closing means 300 and then supplies it thereto, in case the power supply cannot supply power.

FIG. 2 is a detailed block diagram showing the emergency power generating means 500 according to a preferred embodiment of the present invention. Referring to FIG. 2, the emergency power generating means 500 of this embodiment includes a power generator 510, a rectifying circuit 520, a constant-voltage/constant-current circuit 530, a control circuit 540, and an indication lamp 550.

The power generator 510 generates energy to be stored in the capacitor unit 600 (see FIG. 1).

Preferably, the power generator 510 is a common manual power generator, which includes a housing, a magnet mounted and rotated in the housing, and a power generating coil fixed in the housing to surround the magnet. A rotary shaft is provided to the center of the magnet, and one end of the rotary shaft is extended and exposed out of the housing for the purpose of manual rotation. The extended and exposed rotary shaft is coupled with a rotating handle, used for manual rotation.

In this embodiment, a manual power generator that generates an induced electromotive force by rotating the rotating handle connected to the magnet has been exemplarily explained as the power generator 510. However, the present invention is not limited thereto. For example, a means capable of generating energy to be stored in a capacitor, such as a solar power generator, may be sufficiently used.

The rectifying circuit 520 converts an alternative current input from the power generator 510 into a direct current. In addition, the rectifying circuit 520 rectifies it into a direct current of a certain level and then transmits it to the constant-voltage/constant-current circuit 530.

The constant-voltage/constant-current circuit 530 supplies the charged power to the capacitor unit 600 in a constant-voltage/constant-current mode. That is to say, at an initial charging point of the capacitor unit 600, the constant-current mode is kept, and then, if the charged voltage of the capacitor unit 600 is saturated, it is switched into a constant-current mode.

The control circuit 540 is a kind of microprocessor, which monitors a charged current and a charged voltage. In addition, the control circuit 540 controls the constant-voltage/constant-current circuit 530 accordingly so as to switch the constant-voltage mode and the constant-current mode suitably.

In addition, if the control circuit 540 determines that the charging process is completed while monitoring a charged voltage of the capacitor unit 600, the control circuit 540 turns on the indication lamp 550 and then informs a user that the capacitor unit 600 is completely charged.

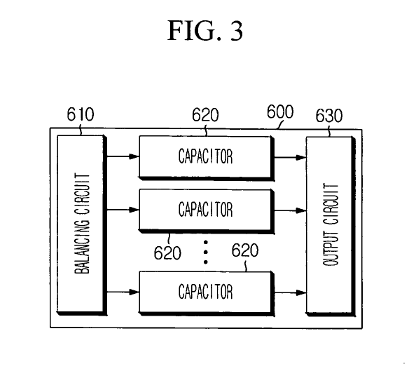

FIG. 3 is a detailed block diagram showing the capacitor unit 600 according to a preferred embodiment of the present invention. Referring to FIG. 3, the capacitor unit 600 of this embodiment includes a balancing circuit 610, a plurality of capacitors 620, and an output circuit 630.

The balancing circuit 610 balances a charged power distributed to each capacitor 620 so that the charged power input from the emergency power generating means 500 may be uniformly charged to each capacitor 620.

The capacitor 620 receives the charged power and stores it as an electric energy. Preferably, the capacitor 620 is an EDLC (Electric Double Layer Capacitor) capable of storing a large amount of charged energy, but not limited thereto.

The output circuit 630 connects electrodes provided to the plurality of capacitors 620 in series and emits the charged power to outside through a pair of electrodes (+, −).

Charging and discharging of the capacitor 620 are conducted through the pair of electrodes (+, −). Thus, the capacitor unit 600 preferably further includes a switch (not shown) capable of selectively connecting the balancing circuit 610 and the output circuit 630. The switch selectively connects the electrodes (+, −) of the capacitor 620 to the balancing circuit 610 or the output circuit 630 by means of the operation of the control circuit 540.

Hereinafter, the operation of the digital doorlock according to the embodiment of the present invention will be described with reference to the above components.

At ordinary times, the doorlock opening/closing means 300 receives power from the power source 100.

The doorlock opening/closing means 300 compares a digital key (k2) input from the key recognition means 200 with a digital key (k1) stored in the memory, and then it opens the doorlock when both keys (k1, k2) are identical.

Meanwhile, if the power of the battery provided to the power source 100 is completely discharged, the power generator 510 is operated by means of intentional manipulation to generate a predetermined alternative current. The alternative current is converted into a direct current of a certain level through the rectifying circuit 520 and then output. The direct current output from the rectifying circuit 520 is applied to the balancing circuit 610 through the constant-voltage/constant-current circuit 530. At this time, the control circuit 540 ordinarily monitors output voltage and output current of the constant-voltage/constant-current circuit 530 to control an operation mode (the constant-voltage mode or the constant-current mode) of the constant-voltage/constant-current circuit 530. In addition, the control circuit 540 detects a charging state of the capacitor unit 600 with reference to the monitored voltage and current values. Then, the control circuit 540 outputs the charging state using the indication lamp or the like.

Then, the balancing circuit 610 distributes the applied charged power in consideration of the charging state of the capacitor 620 so that charged voltages of the capacitors 620 may be kept regularly.

If all of the capacitors 620 are completely charged and thus the current applied to the balancing circuit 610 from the constant-voltage/constant-current circuit 530 is reduced, the control circuit 540 detects it and then interrupts a connection between the balancing circuit 610 and the capacitors 620. In addition, the control circuit 540 connects the output circuit 630 to the capacitors 620.

Finally, the energy stored in the plurality of capacitors 620 is supplied to the doorlock opening/closing means 300 through the output circuit 630. Accordingly, the doorlock opening/closing means 300 is operated temporarily using the emergency power.

In the embodiment of the present invention, an AC power generator is exemplarily explained as the power generator 510. In this consideration, the rectifying circuit 520 for converting an alternative current into a direct current is provided to the emergency power generating means 500. However, a DC power generator may be adopted as an alternative of the AC power generator. In this case, the rectifying circuit 520 provided to the emergency power generating means 500 may be excluded.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

According to the present invention, an ultra capacitor is used as an emergency power source, so a separate emergency opening/closing device for preparation against a complete consumption of the battery is not used, thereby capable of simplifying the configuration of the doorlock.

In addition, since energy is stored and used in an ultra capacitor with good durability, the doorlock apparatus may be used substantially permanently without any maintenance of an energy storage.

What is claimed is:

1. A digital doorlock, comprising:
a power source for supplying an ordinary power;
a key recognition means for receiving a key required for opening a doorlock from outside;
a doorlock opening/closing means for opening/closing the doorlock by comparing a key input from the key recognition means with a key stored therein;
an emergency power generating means for generating an emergency power and controlling the generated power to be converted into a power required for charging capacitors; and
a capacitor unit provided with a plurality of capacitors and storing the electric energy applied from the emergency power generating means into the capacitors, the capacitor unit supplying the energy stored in the capacitors to the doorlock opening/closing means in case the power supply is not able to supply power.

2. The digital doorlock according to claim 1, wherein the capacitor unit includes:
a balancing circuit for controlling a balance of the capacitors with respect to a charged voltage; and
an output circuit for outputting the energy respectively stored in the capacitors together.

3. The digital doorlock according to claim 2,
wherein the capacitor unit further includes a switching means capable of selectively connecting the balancing circuit and the output circuit.

4. The digital doorlock according to claim 1,
wherein the emergency power generating means includes a power generator, and the power generator is a manual power generator using an induced electromotive power.

5. The digital doorlock according to claim 1,
wherein the emergency power generating means includes a power generator, and the power generator includes a solar power generator.

6. The digital doorlock according to claim 4,
wherein the manual power generator is an AC power generator or a DC power generator.
